(19) United States
(12) Patent Application Publication
(10) Pub. No.: US 2009/0326088 A1
(43) Pub. Date: Dec. 31, 2009

(54) Pre-Reacted Isocyanate Product

(75) Inventor: Salvatore A. DiLoreto, Ancaster (CA)

Correspondence Address: DORITY & MANNING, P.A., POST OFFICE BOX 1449, GREENVILLE, SC, 29602-1449, US

(73) Assignee: Elastochem Specialty Chemicals Inc., Brantford (CA)

(21) Appl. No.: 12/487,278

(22) Filed: Jun. 18, 2009

Related U.S. Application Data
(60) Provisional application No. 61/073,663, filed on Jun. 18, 2008.

(51) Int. Cl. C08J 9/00; C08G 18/08

(52) U.S. Cl. 521/116; 521/117; 521/128

(57) ABSTRACT

A foam material is made through a spray process by combining a polyol with a pre-reacted isocyanate. The pre-reacted isocyanate contains an isocyanate pre-reacted with a prefoaming agent, such as a second polyol. The second polyol might be the same or different than the first polyol. Once combined in the presence of a blowing agent, the polyol and the pre-reacted isocyanate form a foam material, such as a polyurethane foam. The foam material is particularly well suited for insulating surfaces. In one embodiment, for instance, the foam is formed and applied on site.

### RELATED APPLICATIONS

The present application is based upon and claims priority to a U.S. Provisional Application having Ser. No. 61/073,663 filed on Jun. 18, 2008.

### BACKGROUND

Properly insulating structures such as buildings and homes continues to gain in importance especially in view of rising energy costs. One of the most common ways to insulate buildings and homes is to install batts of fiberglass or blown fiberglass insulation around the exterior walls of the structure. For example, fiberglass insulation materials are typically used to insulate attics, crawl spaces, and vertical wall cavities. Such materials have been found well suited to preventing heat from escaping from the insulated area in colder months and cool air from escaping from the area in hotter months.

Although fiberglass insulation materials have very desirable R-values in static conditions, the thermal performance of the materials significantly decreases when subjected to air flow. Thus, in the past, builders have applied a spray foam material, such as a polyurethane foam, to a surface to be insulated prior to installing fiberglass insulation. The rigid polyurethane foam has been found to serve as an effective air flow barrier while also providing other beneficial insulation characteristics.

Polyurethane foams are typically formed on site by mixing a polyol with an isocyanate. Isocyanates used in the past have typically comprised aromatic isocyanates, such as diphenylmethane diisocyanate (MDI) or toluene diisocyanate (TDI). Specifically, in order to form a foam, the isocyanate component is combined with a polyol in the presence of a blowing agent and sprayed out of a nozzle onto the surface to be treated.

When producing polyurethane foams as described above, installers are typically required to wear respiratory protection in order to avoid breathing any unreacted isocyanate. For example, the United States Environmental Protection Agency indicates that short-term inhalation of high concentrations of aromatic isocyanates may cause sensitization and asthma. Further, dermal contact with aromatic isocyanates has been found to induce dermatitis and eczema in workers. Long-term inhalation exposure to isocyanates has also been shown to cause asthma, dyspnea and other respiratory impairments.

Thus, when installing polyurethane foams as described above, workers are typically required to wear a Powered Air Purifying Respirator (PAPR) or some other type of respirator that provides a filtered air supply. Further, when applying the foam using a high pressure system, typically a full body suit is recommended to be worn. The above respirators and protective garments are very expensive and very bulky and cumbersome to wear, especially in hot weather.

In view of the above, a need currently exists for a foam system capable of being applied to an adjacent surface that is essentially isocyanate-free. A foam product that is essentially isocyanate-free may be sprayed onto a surface without the need of the installer wearing an extensive respiratory protection system.

A need also exists for a foam system that can be formed from essentially isocyanate-free components for use in various other applications in addition to forming foam insulation.

### SUMMARY

In general, the present disclosure is directed to a process and system for installing a foam insulation on a surface, to a foam product, and to a pre-reacted isocyanate product that may be used to produce a foam material. The surface, for instance, may comprise a portion of a building, a home, or other similar structure. The surface, for instance, may be part of an attic, a crawl space, a vertical wall, or the like. The foam, which may comprise a polyurethane foam, can be formed on site from an A component and a B component. The foam can be co-blown or blown in the presence of a blowing agent, which may comprise water, any other suitable liquid, or any suitable gas. The B component comprises any suitable polyol. In accordance with the present disclosure, the A component comprises an isocyanate, such as an aromatic isocyanate monomer, that has been pre-reacted with a prefoaming agent, such as a second polyol.

In one embodiment, for instance, the A component can contain substantially no free isocyanate monomers. By pre-reacting the isocyanate, the A component becomes safer to handle and use, especially when formed into a foam on site. By pre-reacting the isocyanate, for instance, the B component of the foam system may no longer pose any significant health risk. Further, the need for extensive, self-contained respiratory equipment may be eliminated in some applications.

For example, in one embodiment, the present disclosure is directed to a process for insulating a surface comprising the step of applying a polyurethane foam on the surface. The polyurethane foam is formed by combining an A component with a B component. The B component comprises a first polyol, while the A component may comprise an aromatic isocyanate monomer pre-reacted with a prefoaming agent. The A component, for instance, may contain less than about 1% by weight unreacted isocyanate monomer, such as less than 0.5% by weight unreacted monomer, such as even less than 0.1% by weight unreacted monomer.

In one embodiment, the isocyanate monomer may comprise diphenylmethane diisocyanate, toluene diisocyanate, polyphenyl polymethylene polyisocyanate, or mixtures thereof. The isocyanate monomer can be reacted with any suitable compound. For instance, in one embodiment, the prefoaming agent may comprise a second polyol that may comprise a glycol such as diethylene glycol or triethylene glycol. In other embodiments, the second polyol may comprise a polyoxyalkylene polyol or a polyether triol. The second polyol may comprise, for instance, an ethoxylated alkylene oxide triol, an ethoxylated-capped polypropylene oxide triol, or the like.

In other embodiments, the prefoaming agent may comprise a mono alcohol, an imine, an oxazolidine or combinations thereof.

The first polyol that is combined with the pre-reacted isocyanate monomer may be selected depending upon the desired characteristics of the resulting foam. For example, in one embodiment, the first polyol may be selected so as to form a rigid or semi-rigid foam that has a closed cell structure. The first polyol, for instance, may comprise a glycol, such as dipropylene glycol or tripropylene glycol.

A blowing agent may optionally be combined with the A component and the B component depending upon the particular application. In one embodiment, for instance, water may be used as a blowing agent. In other embodiments, however, the blowing agent may comprise carbon dioxide, a chlorofluorocarbon, a hydrofluorocarbon, a hydrochlorofluorocarbon, a hydrocarbon, or the like. In addition to a blowing agent, a catalyst may also be present. For example, in one embodiment, a catalyst may be contained in the B component.

In addition to a process for insulating a surface, the present disclosure is also directed to an insulated structure. The insulated structure comprises a layer of spray foam insulation located on a surface to be insulated. The spray foam insulation may comprise a polyurethane foam as described above that is formed from an aromatic isocyanate pre-reacted with a prefoaming agent, such as a polyol. In one embodiment, a layer of fiberglass insulation may be installed over or under the layer of spray foam insulation.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a cross-sectional view of one embodiment of an insulated structure made in accordance with the present disclosure; and

FIG. 2 is a diagrammatical view of one embodiment of a system for producing a spray foam insulation in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a foam product and to a pre-reacted isocyanate product that may be used in producing the foam. The pre-reacted isocyanate product, for instance, can be used in numerous applications. Although the isocyanate-free product is particularly well suited to producing foam, the product may be used to produce other materials as well.

In one embodiment, for instance, the isocyanate-free product can be used as part of a processing system for installing foam insulation. Although the foam can be formed off-site and later installed, in one embodiment, the present disclosure is directed to forming the foam on site and spraying the foam directly onto the surface to be insulated. The foam, which may be a polyurethane foam, is formed from a two component system. The two components can be mixed together and sprayed through a nozzle to form the foam insulation material.

In order to form the foam material, the first component contains an isocyanate while the second component contains a polyol. The second component may also contain a catalyst, a blowing agent, a flame retardant, and the like. In accordance with the present disclosure, the isocyanate contained within the first component is pre-reacted with a prefoaming agent. The prefoaming agent, for instance, may comprise a polyol, a mono alcohol, an imine, an oxazolidine, or combinations thereof. Pre-reacting the isocyanate prior to being combined with the second component may eliminate the need for the installer to wear extensive respiratory equipment. In fact, in the past, the structure being insulated typically had to be evacuated during installation of the foam material. By pre-reacting the isocyanate, however, other trade workers may continue to work in a structure while the foam is being installed thus reducing the time to build the structure, providing added savings.

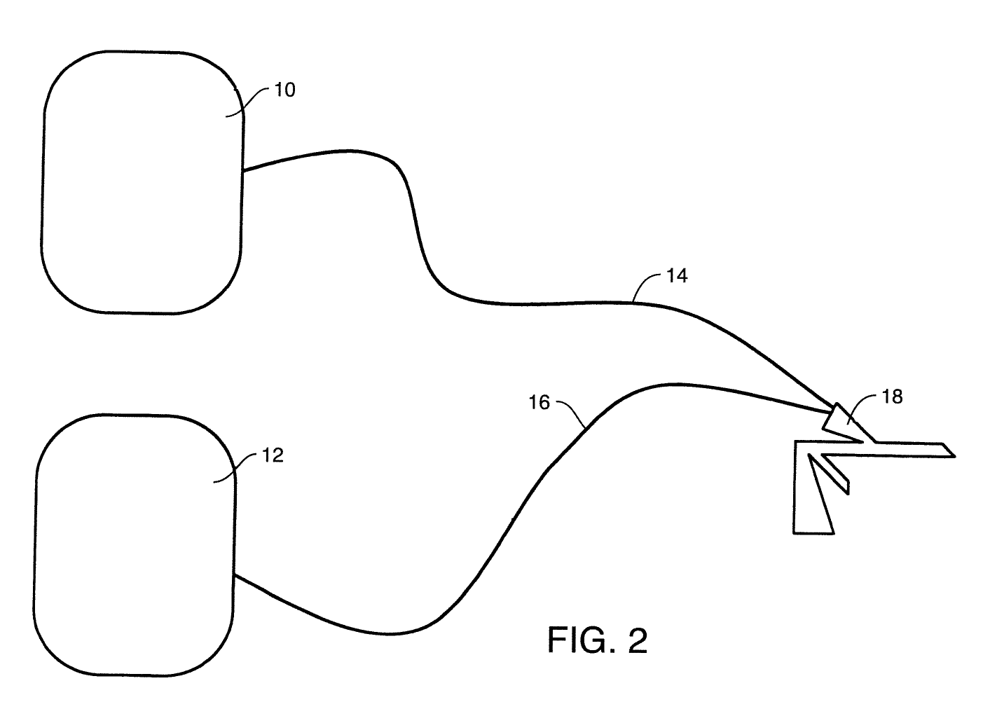

Referring to FIG. 2, for exemplary purposes, one embodiment of a system that may be used to form and install a polyurethane foam material in accordance with the present disclosure is illustrated. As shown, the system includes a first pressurized container 10 for containing a first component typically referred to as the “A” component and a second pressurized container 12 for containing a second component typically referred to as the “B” component. The container 10 is in communication with a nozzle 18 that may comprise a spray gun via a tubular channel 14. Similarly, the second container 12 is in communication with the nozzle 18 by a second tubular channel 16. The tubular channels 14 and 16 may comprise, for instance, hoses.

The two components contained in the two containers 10 and 12 are combined in the nozzle 18 and formed into a foam which may be applied directly to a surface being insulated. The two components can be mixed in the nozzle 18 alone or in the presence of a blowing agent which can be added to the nozzle separately or contained in one of the components.

When the two components are combined in the nozzle 18, an exothermic reaction takes place as the resulting material is emitted from the nozzle. Small bubbles form during the reaction which become trapped in the newly formed material. As the foam is applied to a surface, the foam cures and hardens. In one embodiment, the foam may expand as it cures. The amount of expansion may depend upon the particular reactants being used. Of advantage, the polyurethane foam has natural adhesive qualities which allow the foam to attach and bond to a surface. Ultimately, a rigid or semi-rigid foam can be produced that either has open cells or closed cells.

The amount of pressure that is placed upon the components in the containers 10 and 12 can depend upon the particular application and the desired result. In some embodiments, the tanks 10 and 12 may be under relatively low pressure, such as less than about 200 psi, such as less than about 100 psi. In other embodiments, however, a higher pressure may be desirable. For instance, the containers 10 and 12 may be under a pressure of greater than about 200 psi, such is greater than about 300 psi, such is even greater than about 400 psi. In one embodiment, for example, the containers 10 and 12 may be used in a relatively high pressure system in which the containers are under a pressure of greater than about 900 psi, such as from about 1000 psi to about 1400 psi.

The A component located in the container 10 generally contains a pre-reacted isocyanate in accordance with the present disclosure. The pre-reacted isocyanate is formed by reacting an isocyanate with a prefoaming agent, such as a polyol to form an intermediate polymer or oligomer capable of reacting with component B.

The isocyanate used in the A component can vary depending upon the particular application. In general, the isocyanate is an aromatic isocyanate. Examples of aromatic isocyanates, include, for instance, diphenylmethane diisocyanate (MDI), toluene diisocyanate (TDI), mixtures thereof, or any of there oligomers, pre-polymers, dimmers, trimers, allophanates, or uretidiones.

Other isocyanates that may be used include hexamethylene diisocyanate (HMDI), HDI, IPDI, TMXDI (1,3-bis-isocyanato-1-methylene ethylene benzene), or any of their oligomers, pre-polymers, dimmers, trimers, allophanates and uretidiones.

Further, suitable polyisocyanates include, but are not limited to, toluene-2,4-diisocyanate, toluene-2,6-diisocyanate, (this is TDI 80/20 from above) commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate, 1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenylenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenylisocyanate), 4,4′-methylene bis(dicyclohexylisocyanate), isophorone diisocyanate, PAPI (a polymeric diphenylmethane diisocyanate, or polyaryl polyisocyanate), 1,4-anthracenediisocyanate, 2,5-fluorenediisocyanate, 1,8-naphthalenediisocyanate and 2,6-diisocyanatobenzfuran.

Also suitable are aliphatic polyisocyanates such as the triisocyanate Desmodur N-100 sold by Mobay (Mobay no longer exists, a BAYER company now) which is a biuret adduct of hexamethylenediisocyanate; the diisocyanate Hylene W sold by du Pont, which is 4,4′-dicyclohexylmethane diisocyanate; the diisocyanate IPDI or Isophorone Diisocyanate sold by Thorson Chemical Corp., 25 which is 3-isocyanatomethyl-3,5,5-trimethylcyclohexyl isocyanate; or the diisocyanate THMDI sold by Verba-Chemie, which is a mixture of 2,2,4- and 2,4,4-isomers of trimethyl hexamethylene diisocyanate.

Further examples of suitable isocyanate components include 2,4-tolylenediisocyanate, 2,6-tolylenediisocyanate, 4,4′-diphenylmethanediisocyanate, 4,4′-diphenylthere-diisocyanate, m-phenylenediisocyanate, 1,5-naphthalene-diisocyanate, biphenylenediisocyanate, 3,3′-dimethyl-4,4′biphenylenediisocyanate, dicyclohexylmethane-4,4′diisocyanate, p-xylylenediisocyanate, bis(4-isocyanatophynyl) sulfone, isopropylidene bis(4-phenylisocyanate), tetramethylene diisocyanate, isophorone diisocyanate, ethylene diisocyanate, trimethylene, propylene-1,2-diisocyanate, 15 ethylidene diisocyanate, cyclopentylene-1,3-diisocyanates, 1,2-,1,3- or 1,4 cyclohexylene diisocyanates, 1,3- or 1,4-phenylene diisocyanates, polymethylene ployphenylleisocyanates, bis(4-isocyanatophenyl)methane, 4,4′-diphenylpropane diisocyanates, bis(2-isocyanatoethyl) carbonate, 1-methyl-2,4-diisocyanatocycloheane, chlorophenylene diisocyanates, triphenylmethane-4,4′4″-triisocyanate, isopropyl benzene-a-4-diisocyanate, 5,6-diisocnanatobutylbicyclo [2.2.1]hept-2ene, hexahydrotolylene diisocyanate, 1-methoxyphenyl-2,4-diisocyanate, 4,4′4″-triphenylmethane triisocyanate, polymethylene polyohenylisocyanate, tolylene-2,4,6-triisocyanate, 4,4′-dimethyldiphenylmethane-2,2′5,5′-tetraisocyanate, and mixtures thereof.

As described above, the isocyanate is pre-reacted with a prefoaming agent. In general, the prefoaming agent can comprise any compound that produces an intermediate product capable of reacting with a polyol in the B component. A prefoaming agent should also be selected that results in a composition capable of being sprayed through the nozzle 18. In one embodiment, the prefoaming agent that is pre-reacted with the isocyanate is selected so that either little to no residual isocyanate monomer is left over after the reaction or so that any residual monomer can be easily separated from the pre-reacted product.

Examples of prefoaming agents that may be pre-reacted with the isocyanate include:
1. a hydrocarbon polyol.
2. a saturated polyether polyol;
3. an unsaturated polyether polyol;
4. a saturated polyester polyol;
5. an unsaturated polyester polyol;
6. a caprolactone polyol;
7. a butadiene polyol;
8. a castor oil, soy or bio-based polyol;
9. a mono alcohol;
10. an imine;
11. an oxazolidine; or
12. mixtures thereof and therebetween of the above named agents, in order to produce an at least partially cured polyurethane pre-polymer

The following diagram describes the reaction of a process to prepare a typical pre-reacted isocyanate component where the prefoaming agent comprises a polyol:

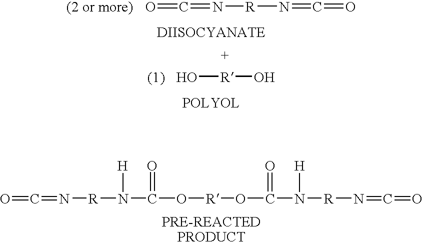

where R and R′ are used to designate any of a variety of suitable alkyl or aromatic groups.

The polyol portion of the polyurethane pre-polymers can be any suitable polyol commonly used within the art, and can include aliphatic or aromatic polyols, including polyester, polyether, and caprolactone-based polyols. The polyols can be made by any suitable production method, but typically and preferably involve 1,4-butanediol, neopentyl glycol, trimethylolpropane, 1,5-pentane diol, glycerol, diethylene glycol being reacted with the diisocyanate. This may also involve reacting ethylene oxide (EO), propylene oxide (PO) or butylene oxide (BO) with the materials such as:
glycerol,
1,2,6-hexanetriol, 1,1,1,-trimethylolpropane,
3-(2-hydroxyethoxy)-1,2-propanediol,
3-(2-hydroxypropoxy)-1,2-propanediol,
   2,4-dimethyl-2-(2-hydroxyethoxy)-methylpentanediol-1,5,1,1,1-tris[(2-hydroxyethoxy)methyl]ethane,
1,1,1,-tris-[(2-hydroxypropoxy)methyl]propane,
   triethanolamine, triisopropanolamine, pyrogallol or phloroglucinol, in order to form a chain-extended polyol.

One example of a suitable chain-extended polyol is the polyether triol sold under the trade name XD 1421, which is made by the Dow Chemical Company. It has a molecular weight of around 4900, and is composed of a ratio of three oxyethylene units randomly copolymerized per one unit of oxypropylene. This is commonly called ethylene oxide above and propylene oxide for the later. It has a hydroxy content of 0.61 meq. OH/g. Another example of a material which is commercially available is Pluracol.™. V-7 made by BASF Wyandotte which is a high molecular weight liquid polyoxyalkylene polyol. Other polyols which might be used at polyether polyols such as Pluracol 492 from BASF, having a molecular weight of 2000. Alternatively, saturated polyester polyols such as Desmophen 2500 from Bayer, having a molecular weight of 1000 might be used. Further, castor oils such as DB caster oil or regular commercial grades of castor oil available from for example, CAS Chem, might also be used. Additionally, polybutadiene resins, such as Poly BD R45T, available from Sartomer, can be used. However, a wide variety of polyols might be used. Further, combinations of various polyols, or types of polyols might also be used.

The preferably chain extended polyol is capped with a polyisocyanate to form the pre-polymer. The isocyanate component of the polyisocyanate preferably has a functionality of 2.0 or more, and more preferably, a functionality of between 2.0 and 3.0, and can include diisocyanates and polyisocyanates of the aliphatic, alicyclic, or aromatic types. The amount and type of isocyanate monomer used, or used in the production of the isocyanate component will directly affect the level of isocyanate groups present. For example, hexamethylene diisocyante (HDI), has a monomeric level of isocyanate of 50% NCO. Other materials will have different monomeric NCO levels, such as, for example, Bis-(4-lsocyanatocyclohexyl)methanes (H12MDI) at 31.8% NCO; isophorone diisocyanate (IPDI) at 37.5% NCO; toluene diisocyanate (TDI) at 48% NCO; or methyl diphenyl diisocyanate (MDI) at 28-34% NCO. When reacted to form the isocyanate prepolymer component, the monomeric NCO level will affect the isocyanate level of the resulting prepolymer material.

When forming the pre-reacted isocyanate, in one embodiment, excess prefoaming agent may be present during the reaction in order to minimize any resulting residual isocyanate monomer. After the reaction is completed, in some embodiments, it may be necessary to remove or strip off any remaining isocyanate monomer. In one embodiment, for instance, the resulting composition may be vacuum stripped in order to remove any residual monomer. Ultimately, the resulting isocyanate composition should contain residual isocyanate monomer in an amount less than about 1% by weight, such as an amount less than about 0.5% by weight, such as an amount less than about 0.1% by weight, such as an amount less than about 0.05% by weight, such as an amount less than about 0.01% by weight, such as an amount even less than about 0.001% by weight.

The B component contained in the second pressurized container 12 contains any suitable polyol capable of reacting with the pre-reacted isocyanate in forming a foam material. Selection of the polyol contained in the B component may depend on numerous factors. For instance, the polyol selected for forming the foam can influence the final properties of the material.

As used herein, “polyol” refers to a molecule than contains more than one hydroxyl group. Thus, in one embodiment, the polyol may comprise a diol. Polyols that may be contained in component B include various glycols, such as ethylene glycol, diethylene glycol, or the like. Other polyols that may be used include 1,4-butanediol. The polyol may also comprise a polyether polyol or a polyester polyol. Examples of polyether polyols include polyols that have been extended with propylene oxide, ethylene oxide or both. Polyester polyols, on the other hand, are formed through polyesterification.

The polyol may have any suitable molecular weight. In general, more rigid foam materials are formed using polyols with lower molecular weight. For example, in one embodiment, the molecular weight of the polyol may be less than about 1000, such as from about 200 to about 800. In an alternative embodiment, however, the molecular weight of the polyol may be greater than about 1000, such as from about 2000 to about 10,000.

In one embodiment, the polyol contained in the B component may comprise an aromatic amine polyol. In this embodiment, for instance, the polyol may have a hydroxyl number ranging from about 300 to about 600.

In an alternative embodiment, the polyol contained in the B component comprises an ethylene oxide-capped polyol. In still another embodiment, the polyol may comprise a polyoxypropylene-capped polyol. When using a polyether polyol, for instance, the polyol may comprise a diol or a triol. The polyol may have a hydroxyl number for about 300 to about 3000, such as from about 800 to about 2500.

In addition to a polyol, the B component may also contain a catalyst. The catalyst may comprise, for instance, an amine compound or an organometallic complex. Amine catalysts that may be used include triethylenediamine, dimethylcyclohexylamine, dimethylethanolamine, tetramethylbutanediamine, bis-(2-dimethylaminoethyl)ether, triethylamine, pentamethyldiethylenetriamine, benzyldimethylamine, and the like.

Organometallic catalysts that may be used include compounds based on mercury, lead, tin, bismuth, or zinc. Particular examples of organometallic catalysts are alkyltincarboxylates, oxides and mercaptides oxides.

It should be understood, however, that in some applications a catalyst may not be needed.

To form the foam material, component A is combined with component B under pressure and in the presence of a blowing agent. The relative amount of component A that is combined with component B generally depends on the particular reactants that are used. In general, the two components are combined together in stoichiometric amounts or in the presence of excess polyol.

The blowing agent, in one embodiment, may comprise water. In fact, water has been found to be well suited for use in the process of the present disclosure when using the pre-reacted isocyanate. When water is used as the blowing agent, the water may be contained in the B component.

In addition to water, other blowing agents that may be used include chlorofluorocarbons, hydrofluorocarbons, or hydrochlorofluorocarbons. Still other blowing agents that may be used include carbon dioxide, pentane or various hydrocarbons.

The amount of blowing agent used in any particular application depends upon the reactants, the pressure at which the components are mixed, and various other factors. In general, for instance, the blowing agent may be present in an amount greater than zero to greater than about 20 parts by weight. The particular blowing agent used in the process and the amount of blowing agent may also have an impact upon the cell structure of the resulting foam. For instance, use of a particular blowing agent may result in an open cell structure or a closed cell structure.

When forming a foam material from component A and component B as described above, the foam material can be created offsite and installed or created onsite. When created onsite, for instance, the components can be mixed together and sprayed directly on the surface to be insulated.

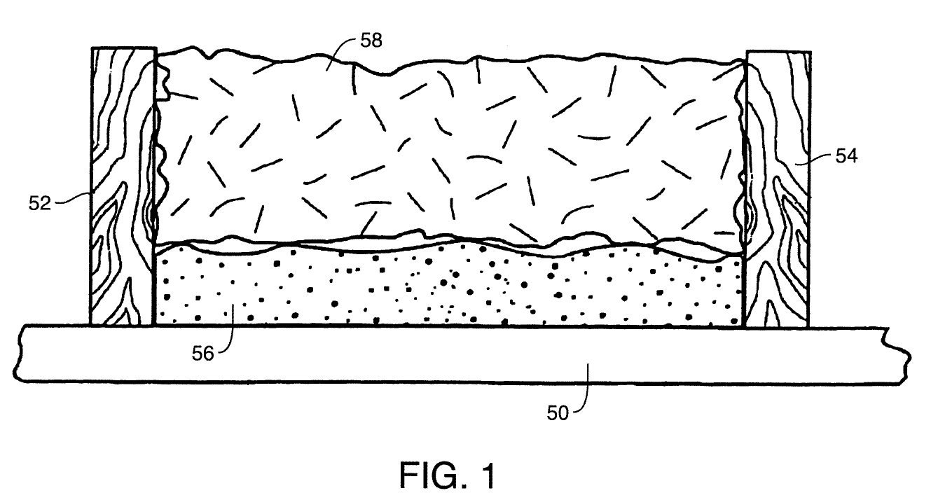

Referring to FIG. 1, for exemplary purposed only, a surface 50 insulated in accordance with the present disclosure is shown. More particularly, FIG. 1 is intended to illustrate a cross-sectional view of an insulated wall cavity. It should be understood, however, that foams made according to the present disclosure can be used to insulate various other areas of a structure or building as well. In this embodiment, the surface 50 comprises a wall that is attached to a pair of studs 52 and 54. In between the pair of studs 52 and 54 is a layer of foam material 56 made in accordance with the present disclosure. The foam insulation 56 is applied to the surface 50 in order to insulate the wall and particularly prevent airflow through the cavity.

As shown, in this embodiment, the foam material 56 is positioned in between the surface 50 and a layer of other insulation 58. The insulation 58 may comprise, for instance, fiberglass insulation, cellulose insulation, or the like. When the foam material 56 is combined with a batt of insulation material 58 as shown in FIG. 1, the foam material can serve as an air barrier for preventing or reducing airflow from reaching the batt of insulation 58 which may have detrimental effects on the ability of the batt of insulation to insulate the surface. Thus, the foam material 56 can block or substantially block airflow through the cavity and thereby maintain or even improve the R-value of the batt of insulation 58.

In the embodiment illustrated in FIG. 1, the foam material 56 is positioned directly adjacent to the surface 50. It should be understood, however, that in other embodiments, the batt of insulation 58 may be positioned in between the surface 50 and the foam material 56. In still another embodiment, two layers of foam material 56 may be provided. In this embodiment, the batt of insulation 58 may be positioned in between the two foam layers.

In addition to wall cavities as shown in FIG. 1, the foam material of the present disclosure may be used to insulate any other suitable surface. Further, the foam insulation may be used with a batt of insulation as shown in FIG. 1 or without the batt of insulation.

In one embodiment, when the foam material is used to insulate a structure without the use of any other insulation materials, the foam may be applied to surfaces in order to fill any cavities present on the surfaces. For example, as shown in FIG. 1, in one embodiment, the foam material may be used to completely fill the space in between the studs 52 and 54. This manner of using the foam is sometimes referred to as a “full cavity” application.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. An isocyanate-free product comprising an aromatic isocyanate monomer pre-reacted with a prefoaming agent, the prefoaming agent comprising a polyol, a mono alcohol, an imine, an oxazolidine, or mixtures thereof, the product containing less than 0.5% by weight of unreacted isocyanate monomer.

2. A product as defined in claim 1, wherein the aromatic isocyanate monomer comprises toluene diisocyanate or diphenylmethane diisocyanate.

3. A product as defined in claim 1, wherein the aromatic isocyanate monomer comprises a mixture of toluene diisocyanate and diphenylmethane diisocyanate.

4. A product as defined in claim 1, wherein the prefoaming agent comprises a polyol.

5. A product as defined in claim 4, wherein the polyol comprises a polyether triol.

6. A product as defined in claim 5, wherein the polyether triol comprises an ethoxylated alkylene oxide triol or an ethoxylated-capped polypropylene oxide triol.

7. A polyurethane formed from the product defined in claim 1.

8. A polyurethane as defined in claim 6, wherein the polyurethane was formed by reacting the isocyanate-free product with a polyol.

9. A polyurethane as defined in claim 6, wherein the polyurethane comprises a foam.

10. A product as defined in claim 1, wherein the prefoaming agent comprises a mono alcohol.

11. A product as defined in claim 1, wherein the prefoaming agent comprises an imine.

12. A product as defined in claim 1, wherein the prefoaming agent comprises an oxazolidine.

13. A system for forming a polyurethane foam comprising an A component and a B component, the A component comprising the isocyanate-free product as defined in claim 1, the B component comprising a polyol.

14. A system as defined in claim 13, wherein the B component further comprises a catalyst.

15. A system as defined in claim 14, wherein the B component further comprises a blowing agent.

16. A system as defined in claim 15, wherein the blowing agent comprises water.

17. A polyurethane as defined in claim 8, wherein the polyurethane comprises an open celled foam.

18. A polyurethane as defined in claim 8, wherein the polyurethane comprises a closed celled foam.

19. A polyurethane as defined in claim 8, wherein the polyurethane comprises a rigid foam.

20. A polyurethane as defined in claim 8, wherein the polyurethane comprises an elastomeric foam.
